(19) United States
(12) Patent Application Publication
(10) Pub. No.: US 2005/0174230 A1
(43) Pub. Date: Aug. 11, 2005

(54) Accident warning device

(76) Inventor: Miyoji Matoba, Wajima-shi (JP)

Correspondence Address: JOHN S. PRATT, ESQ;KILPATRICK STOCKTON, LLP, 1100 PEACHTREE STREET, ATLANTA, GA, 30309, US

(21) Appl. No.: 10/487,195

(22) PCT Filed: Aug. 23, 2002
(86) PCT No.: PCT/JP02/08511

(30) Foreign Application Priority Data
Aug. 24, 2001 (JP) 2001-254255
Feb. 15, 2002 (JP) 2002-37957
Aug. 16, 2002 (JP) 2002-237593

(51) Int. Cl. G08B 23/00

(52) U.S. Cl. 340/517; 340/425.5

(57) ABSTRACT

A disaster-related warning apparatus (1) housed in a case (10) installable to a building or equipment, including at least one type of disaster sensing means (20) for outputting a detection signal upon sensing a predetermined type of disaster, and notification means (30) for making an instruction about a location of emergency equipment or appliance prepared for the disaster optically or by an audio message, the notification means being activated in response to the detection signal outputted by the disaster sensing means (20).

### TECHNICAL FIELD

This invention relates to a disaster-related warning apparatus to be used by being attached onto a building or equipment.

### BACKGROUND ART

In general, in facilities applying to predetermined requirements, it is obliged to install fire extinguishers and emergency exits, the numbers of which accord with scales of the facilities, in preparation for occurrences of a fire and earthquake. Moreover, also in ordinary households, as well as the fire extinguishers, emergency equipment such as flashlights, portable radios and emergency food is prepared for such disasters though such a preparation is not a duty.

These equipment and appliances are ones capable of exerting effects thereof only when being used instantaneously in case of the occurrences of disasters.

However, the disasters do not always occur in an arousal period while a mental activity and a physical activity are normal, and for example, sometimes occur during asleep and drinking periods. In such cases, because of an extreme panic and because a body and a mentality are nonarounsal, an installation position of the fire extinguisher, a position of the emergency exit or a position of the flashlight cannot be remembered quickly. This will cause situations where the fire extinguisher is not effectively utilized for initial extinction, it takes time to evacuate, and an evacuation cannot help but being performed while abandoning the emergency equipment such as the flashlight. Specifically, a possibility is extremely high that the emergency equipment and appliances are not effectively utilized in case of a sudden occurrence of the disaster if these emergency equipment and appliances are prepared only in a nominal manner.

Conventionally, such problems have been dealt as matters concerning a daily posture, which include an extinction training and the like, and such measures as assisting a person to know the positions of the emergency equipment and appliances by an electromechanical device and the like have not been taken. Even in a large-scale facility built for a business to welcome any guests, such as a hotel obliged to install fire hydrants, the measures against the problems are only taken by providing a red lamp above a door of a fire hydrant cabinet such that any unspecified third party can get to know the presence of the fire hydrant.

Specifically, there has conventionally been a problem that the emergency equipment and the emergency appliances, which have been previously prepared for the occurrences of disasters, are difficult to be effectively utilized in case of an actual disaster because of the panic and forgetting of a storage place of the equipment or appliances.

### DISCLOSURE OF THE INVENTION

This invention has been created in consideration of the above-described conventional problems. It is an object of the present invention to provide a disaster-related warning apparatus which automatically operates upon sensing an occurrence of a disaster and can clearly instruct a person about a position of emergency equipment or emergency appliance by appealing to either one or both of visual and auditory sensations thereof.

In order to achieve the above-described object, a first aspect of this invention is a disaster-related warning apparatus housed in a case installable to either of a building and equipment, including at least one type of disaster sensing means for outputting a detection signal upon sensing a predetermined type of disaster, and notification means for making an instruction about a location of either of emergency equipment and appliance prepared for the disaster optically or by an audio message, the notification means being activated in response to the detection signal outputted by the disaster sensing means.

According to the above-described constitution, the disaster-related warning apparatus automatically operates upon sensing the occurrence of a disaster and can clearly instruct a person about the position of the emergency equipment or emergency appliance by appealing to either one or both of visual and auditory sensations thereof.

Thus, in case of the occurrence of the disaster, a clear instruction can be made to a fire operator and an evacuee about the emergency equipment or the emergency appliances, for example, such as the fire extinguisher and the emergency exit. Accordingly, expansions of physical and property damages caused by that the locations of the emergency equipment and appliances are inapparent due to a panic and a nonarounsal state of mentality can be restricted to the minimum.

A second aspect of this invention is the disaster-related warning apparatus according to the first aspect, wherein the disaster sensing means includes any of a temperature sensor for sensing heat in case of fire, a gas sensor for sensing smoke in case of the fire, a sound sensor for sensing an alarm sound of an emergency bell, and a vibration sensor for sensing an earthquake.

A third aspect of this invention is the disaster-related warning apparatus according to the first aspect, wherein the notification means includes either of a laser pointer and an LED, and the laser pointer is constituted such that a pointing orientation is arbitrarily adjustable and a beam is swingable within a required range while using a set pointing orientation as a reference.

A fourth aspect of this invention is the disaster-related warning apparatus according to the first aspect, wherein the notification means includes recording means capable of recording and reproducing at least one type of audio message corresponding to the type of disaster.

A fifth aspect of this invention is a disaster-related warning apparatus to be used by being attached onto either of a building and equipment, including fire sensing means for outputting a detection signal upon sensing any of heat and smoke in case of fire and an alarm sound of an emergency bell, earthquake sensing means for outputting a detection signal upon sensing an earthquake, optical notification means capable of making an optical instruction about a location of either of emergency equipment and appliance prepared for a disaster, fire-case audio notification means capable of issuing an audio message to instruct about the location of either of the emergency equipment and appliance prepared for the disaster as well as an audio message corresponding to an occurrence of a fire, earthquake-case audio notification means capable of issuing the audio message to instruct about the location of either of the emergency equipment and appliance prepared for the disaster as well as an audio message corresponding to an occurrence of an earthquake, and controlling means for selecting either one of the fire-case audio notification means and the earthquake-case notification means and activating the optical notification means and the selected one of the fire-case audio notification means and the earthquake-case notification means based on the detection signal outputted by either thereof, wherein the controlling means activates the optical notification means and the fire-case audio notification means upon receiving the detection signal only from the fire sensing means, activates the optical notification means and the earthquake-case audio notification means upon receiving the detection signal only from the earthquake sensing means, and activates the optical notification means and the fire-case audio notification means upon receiving the detection signals from the fire sensing means and the earthquake sensing means.

### BRIEF DESCRIPTION OF THE DRAWINGS

FIG. 1 is a front perspective view showing a disaster-related warning apparatus according to a first embodiment of this invention.

FIG. 2 is a back perspective view of the disaster-related warning apparatus of FIG. 1.

FIG. 3 is a cross-sectional view of principal portions of the disaster-related warning apparatus of FIG. 1.

FIG. 4 is a circuit system diagram of a controller of a disaster-related warning apparatus of this invention.

FIG. 5 is an explanatory view showing an example of installation of the disaster-related warning apparatus of this invention.

FIG. 6 is a perspective view showing a disaster-related warning apparatus according to a second embodiment of this invention.

FIG. 7 is an explanatory perspective view of principal portions of the disaster-related warning apparatus of FIG. 6.

FIG. 8 is a cross-plan view of the principal portions of the disaster-related warning apparatus of FIG. 7.

FIG. 9 is an explanatory perspective view showing principal portions of a disaster-related warning apparatus according to a third embodiment of this invention.

FIG. 10 is an explanatory perspective view schematically showing a disaster-related warning apparatus according to a fourth embodiment of this invention.

FIG. 11 is a perspective view showing a disaster-related warning apparatus according to a fifth embodiment of this invention.

### BEST MODE FOR CARRYING OUT THE INVENTION

Embodiments of this invention will be described with reference to the drawings.

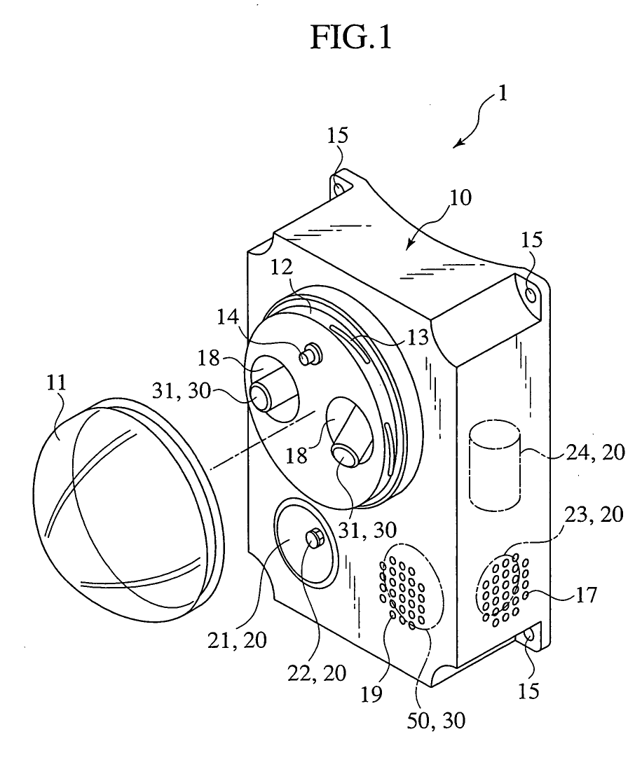

Note that, in the description below, a right side of a disaster-related warning apparatus means right sides in the drawings of FIGS. 1, 6 and 11 (the same direction as of a right side for a person observing the disaster-related warning apparatus from front), and a left side of the disaster-related warning apparatus means left sides in the drawings of FIGS. 1, 6 and 11 (the same direction as of a left side for the person observing the disaster-related warning apparatus from front).

### First Embodiment

As shown in FIGS. 1 to 4, a disaster-related warning apparatus 1 houses disaster sensing means 20, notification means 30, controlling means and an unillustrated battery in a case 10. The disaster sensing means 20 includes a temperature sensor 21, a gas sensor 22 and a sound sensor 23 as fire sensing means, and a vibration sensor 24 as earthquake sensing means. The notification means 30 includes laser pointers 31 as optical notification means, and an audio generation device 50 as audio notification means.

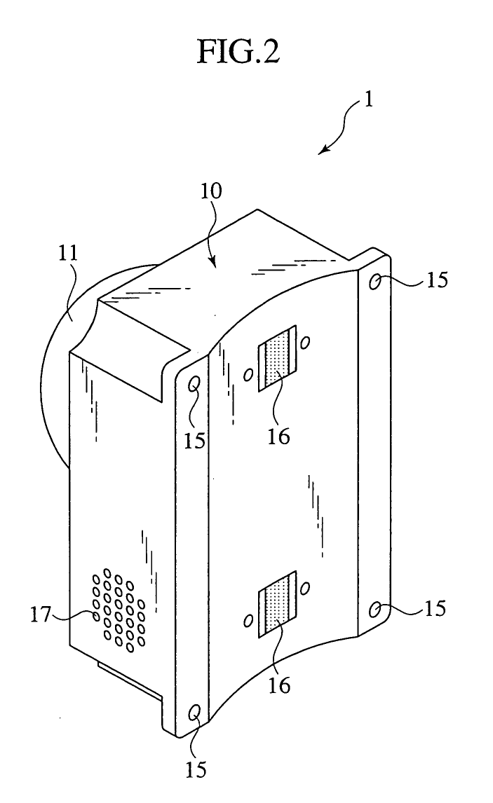

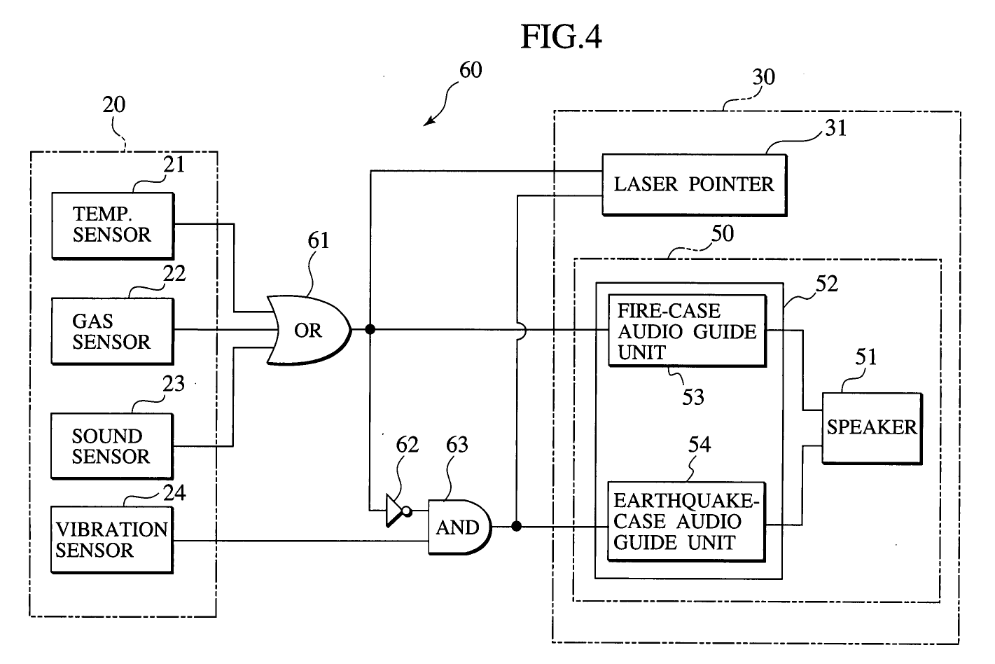

As shown in FIGS. 1 and 2, in the case 10 made of an engineering plastic mold such as ABS, this disaster-related warning apparatus 1 houses the temperature sensor 21, the gas sensor 22, the sound sensor 23 and the vibration sensor 24, which are the disaster sensing means 20, the two laser pointers 31 and the audio generation device 50, which are the notification means 30, controlling means 60 (refer to FIG. 4) for these disaster sensing means 20 and notification means 30, and the battery.

The case 10 is substantially a hexahedron in which four corner portions are partially cut away. On a front surface of the case 10, a circular pedestal 12 is formed. Onto the circular pedestal 12, a transparent resin-made protection cap 11 which is formed in a dome shape to cover fronts of the laser pointers 31 is attached. The protection cap 11 can be easily detached by use of partial threads formed on an outer peripheral surface of the circular pedestal 12. On the circular pedestal 12, a reset button 14 for manually stopping an operation of the disaster-related warning apparatus 1 is arranged.

On the four cut corners of the case 10, screw holes 15 for use when the disaster-related warning apparatus 1 is attached onto a wall surface, ceiling surface or the like of a building are provided. Moreover, a back surface of the case 10 is formed into a concave shape corresponding to an outer curvature of a tank of a fire extinguisher of a popular size. In two spots in the vertical direction of this concave back surface, magnet catches 16 for attaching the case 10, that is, the disaster-related warning apparatus 1 onto an outer periphery of the fire extinguisher by use of magnetic force are embedded. As fixing means for attaching the case 10, that is, the disaster-related warning apparatus 1, a band or the like with which the outer periphery of the fire extinguisher tank is wound can also be adopted.

The temperature sensor 21 is arranged on the front surface of the case 10 and one for sensing heat generated in case of fire. As a sensing element of the temperature sensor 21, for example, a thermistor and the like can be utilized. The gas sensor 22 is arranged on the front surface of the case 10 and one for sensing smoke generated in case of fire. As a sensing element of the gas sensor 22, for example, one of a semiconductor type, in which a detection circuit is simplified because an output thereof is large, and one of a light interference type, which is easy to maintain and long-life, are preferable. Such a temperature/gas sensor unit, which is constituted of the temperature sensor 21 having a sensing surface similar to a parabola curve, and the gas sensor 22 located on the center of the temperature sensor 21, is one widely used as a fire detection sensor of an automatic sprinkler device.

The sound sensor 23 is one for sensing an alarm sound of an emergency bell, and includes a compact microphone arranged to face to a large number of through holes 17 provided on a side surface of the case 10, and an unillustrated discrimination circuit discriminating the alarm sound of the emergency bell from detection sounds of the microphone. In order to prevent a malfunction by other sounds than the alarm sound of the emergency bell, the discrimination circuit is constituted by use of a resonance circuit resonating to a frequency of the alarm sound of the emergency bell, a bandpass filter passing only a signal of the frequency of the alarm sound of the emergency bell, or the like. Thus, sensitivity of the sound sensor 23 becomes extremely low for the other sounds than the alarm sound of the emergency bell.

The vibration sensor 24 is one for sensing an earthquake by use of a mechanical detection element using a fixed point, and arranged in an inside of the case 10.

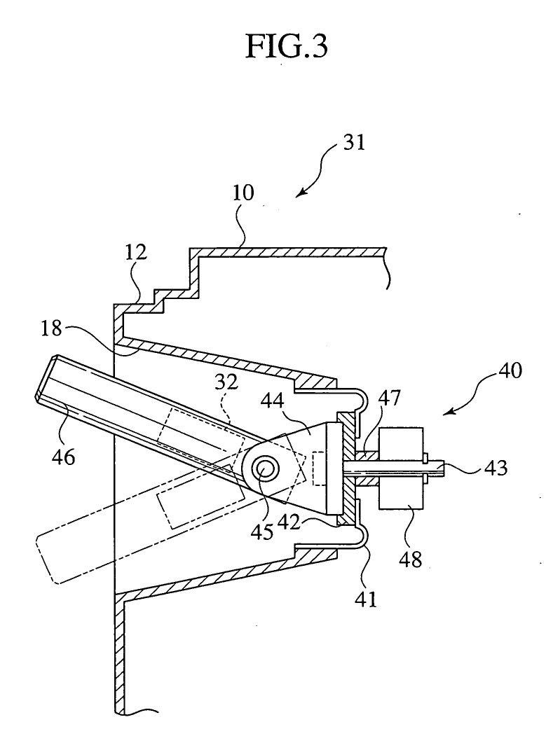

The two laser pointers 31 are ones similar to each other, and as shown in FIG. 3, each of the laser pointers 31 is constituted of a semiconductor laser unit 32, and of a holding device 40 attaching this semiconductor laser unit 32 into a loading aperture 18 formed on the circular pedestal 12 of the case 10 while being tapered to be expanded forward. This attachment is performed such that an angle adjustment of the semiconductor laser unit 32 is possible and vibrations can be given thereto.

The holding device 40 includes a bottom plate 42 attached onto a rear end opening portion of the loading aperture 18 while interposing a diaphragm-shaped elastic member 41 therebetween, a bracket 44 attached onto a front surface of the bottom plate 42 while interposing a center axle 43 therebetween and around the center axle 43 such that an angle thereof is adjustable, and a cylindrical body 46 extended forward from the bracket 44 in a cantilever fashion and attached onto the bracket 44 such that an orientation thereof is adjustable while using a pin 45 as a fulcrum. The semiconductor laser unit 32 is housed in this cylindrical body 46. With respect to the bottom plate 42 attached onto the case 10 while interposing the elastic member 41 therebetween, the angle of the bracket 44 is adjusted around the center axle 43, and with respect to this bracket 44, the orientation of the cylindrical body 46 is adjusted while using the pin 45 as the fulcrum. Thus, the orientation of the semiconductor laser unit 32 housed in the cylindrical body 46 is adjusted and set in every direction within a range of the loading aperture 18.

Moreover, the holding device 40 includes an electromagnetic vibrator 48 attached onto the center axle 43 extended rearward from the bottom plate 42 while sandwiching an elastic spacer 47 between the electromagnetic vibrator 48 itself and the bottom plate 42. By an operation of this vibrator 48, random vibrations can be given to the bottom plate 42. Accordingly, by activating the vibrator 48 when using each laser pointer 31, a laser beam generated from each semiconductor laser unit 32 can be vibrated while using the above-described set orientation as a reference, and the existence of the laser beam can be made more conspicuous in comparison with the case where the laser beam is static in one spot.

The audio generation device 50 includes a speaker 51 arranged to face to the large number of through holes provided on the front surface of the case 10, and an IC memory 52 capable of recording/reproducing sounds. This IC memory 52 includes a fire-case audio guide unit 53 and an earthquake-case audio guide unit 54 (refer to FIG. 4). In the fire-case audio guide unit 53, an audio message instructing a person about a location of emergency equipment or appliances prepared for a fire is previously recorded together with an audio message corresponding to an occurrence of such a disaster. In the earthquake-case audio guide unit 54, an audio message instructing a person about a location of emergency equipment or appliances prepared for an earthquake is previously recorded together with an audio message corresponding to an occurrence of such a disaster.

As shown in FIG. 4, the controlling means (controller) 60 includes an OR gate 61, in which respective outputs of the temperature sensor 21, gas sensor 22 and sound sensor 23 are connected to an input side, and each laser pointer 31 and the fire-case audio guide unit 53 are connected to an output side, an inverter 62 connected to the output side of the OR gate 61, and an AND gate 63, in which outputs of the inverter 62 and vibration sensor 24 are connected to an input side, and each laser pointer 31 and the earthquake-case audio guide unit 54 are connected to an output side.

Thus, when at least one of the temperature sensor 21, the gas sensor 22 and the sound sensor 23 generates a detection signal, the OR gate 61 outputs the detection signal to each laser pointer 31 and the fire-case audio guide unit 53, and the controlling means 60 activates each laser pointer 31 and the fire-case audio guide unit 53. Moreover, when any of the temperature sensor 21, gas sensor 22 and sound sensor 23 does not generate a detection signal and only the vibration sensor 24 generates a detection signal, the AND gate 63 outputs the detection signal to each laser pointer 31 and the fire-case audio guide unit 54, and the controlling means 60 activates each laser pointer 31 and the fire-case audio guide unit 54. Furthermore, when at least one of the temperature sensor 21, gas sensor 22 and sound sensor 23 generates a detection signal in addition to the vibration sensor 24, the OR gate 61 outputs the detection signal to each laser pointer 31 and the fire-case audio guide unit 53, and the controlling means 60 activates each laser pointer 31 and the fire-case audio guide unit 53. Accordingly, for example, when at least one of the temperature sensor 21, gas sensor 22 and sound sensor 23 outputs the detection signal in addition to the vibration sensor 24 while only the vibration sensor 24 generates the detection signal to activate each laser pointer 31 and the earthquake-case audio guide unit 54, though each laser pointer 31 continues to operate, the operation of the earthquake-case audio guide unit 54 is stopped, and instead of this, the fire-case audio guide unit 53 will operate.

This disaster-related warning apparatus 1 includes the battery in the case 10. In addition, in the case 10, the screw holes 15 and the magnet catches 16 for attaching the disaster-related warning apparatus 1 onto a building or equipment are provided, and therefore, the disaster-related warning apparatus 1 can be installed by being attached onto a ceiling, a wall or a fire extinguisher without any wiring. Then, under conditions where an earthquake or a fire occurs or an emergency bell rings, the disaster-related warning apparatus 1 is activated automatically, can irradiate the laser beams toward emergency equipment installed in a predetermined position or from a position of the emergency equipment, and can guide a fire operator to a position of the fire extinguisher or an evacuee to an emergency exit by means of the audio message.

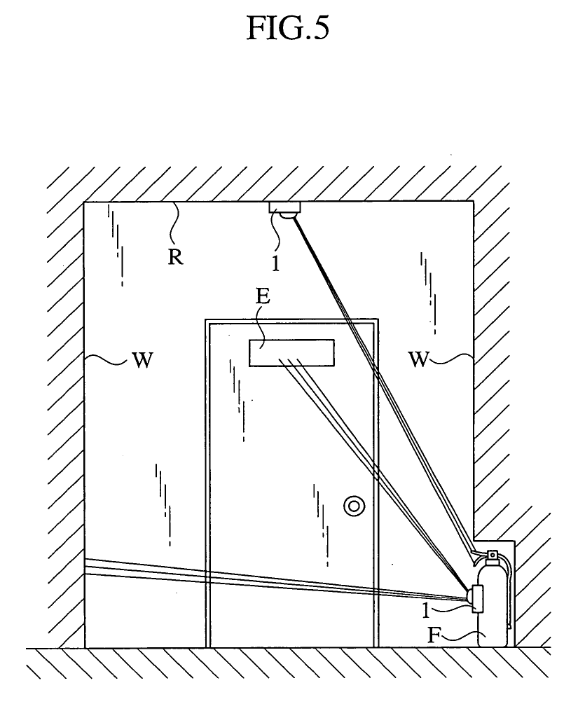

Specifically, as shown in FIG. 5, for example, in a common passage of a hotel or the like, the disaster-related warning apparatus 1 is attached onto a ceiling surface R around which is apt to be filled with smoke and heat, and the disaster-related warning apparatus 1 is previously attached onto a fire extinguisher F itself as emergency equipment installed in a recess portion of a wall surface W of the passage. In this case, the laser pointers 31 of the disaster-related warning apparatus 1 on the ceiling surface R are previously directed to the fire extinguisher F, and the laser pointers 31 of the disaster-related warning apparatus 1 on the fire extinguisher F are previously directed to the wall surface W opposite thereto and to a display board of an emergency exit E.

When it is assumed that the emergency bell rings in such a state, the sound sensor 23 senses the ringing, and activates the laser pointers 31 to irradiate the laser beams, and the audio generation device 50 issues an audio message. Accordingly, hotel visitors and the like who have caught the emergency bell and run out to the passage can instantaneously obtain information concerning a width of the passage, a position of the emergency exit E and a position of the fire extinguisher F, and appropriate evacuation information can be given by audio to a visually challenged evacuee.

Moreover, the audio generation device 50 includes the IC memory 52 capable of recording/reproducing sounds, and accordingly, contents of the message issued by the audio generation device 50 can be rewritten. For example, a message of contents telling “Emergency exit is on left-hand side of passage” can be changed individually to appropriate contents such as: “Emergency exit is on right-hand side of passage” for persons in rooms on the other side of the passage. Accordingly, an application range of the disaster-related warning apparatus 1 can be expanded.

Moreover, each laser pointer 31 can adjust and set the orientation of the semiconductor laser unit 32 to every direction within the range of the loading aperture 18 of the case 10. Accordingly, even if the case 10 cannot be installed while being directed to an appropriate direction due to conditions of an installation spot of the disaster-related warning apparatus 1, the laser pointer 31 is directed to a target irrespective of an orientation of the case 10, thus making it possible to illuminate the target in case of the disaster. Moreover, limitations on an attachment position of the case 10 are resolved.

### Second Embodiment

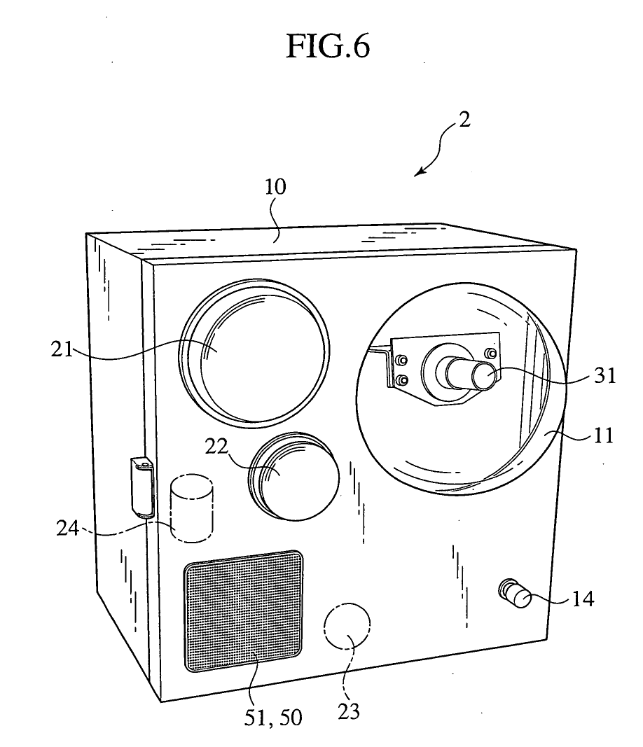

As shown in FIGS. 6 to 8, a disaster-related warning apparatus 2 has a substantially similar structure to that of the disaster-related warning apparatus 1 though an exterior appearance thereof differs from that of the disaster-related warning apparatus 1 shown in FIGS. 1 to 4. Portions of the disaster-related warning apparatus 2, which are similar to those of the disaster-related warning apparatus l, are shown while being added with the same reference numerals as those for use in FIGS. 1 to 4. Specifically, in a case 10, this disaster-related warning apparatus 2 houses a temperature sensor 21, a gas sensor 22, a sound sensor 23 and a vibration sensor 24 as disaster sensing means 20, a laser pointer 31 and an audio generation device 50 as notification means 30, controlling means 60 (refer to FIG. 4), and an unillustrated battery.

A different one of this disaster-related warning apparatus 2 from the disaster-related warning apparatus 1 shown in FIGS. 1 to 4 is mainly a holding device 70 for the laser pointer 31.

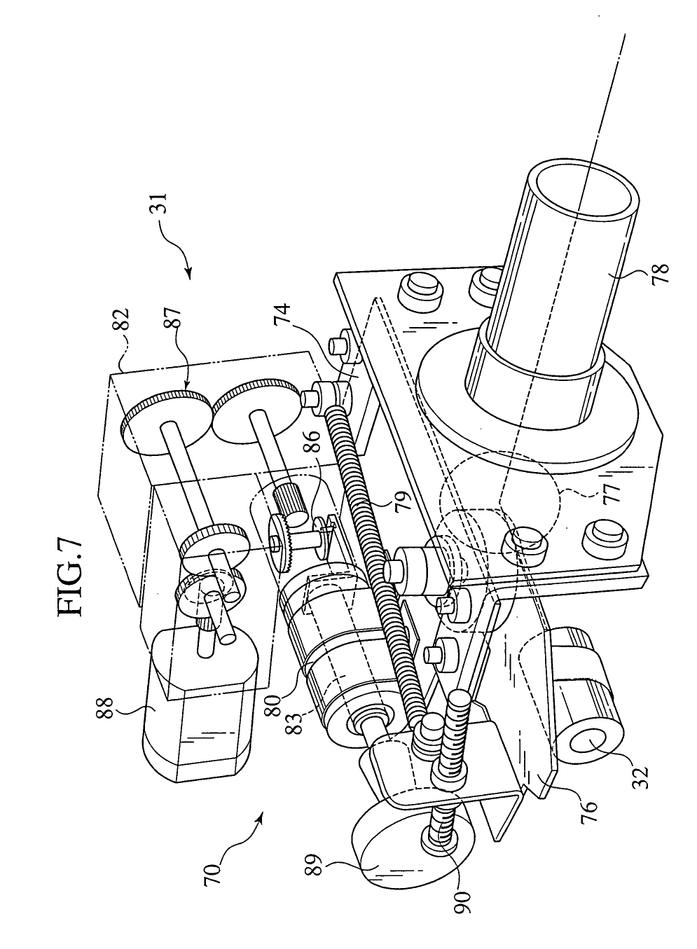

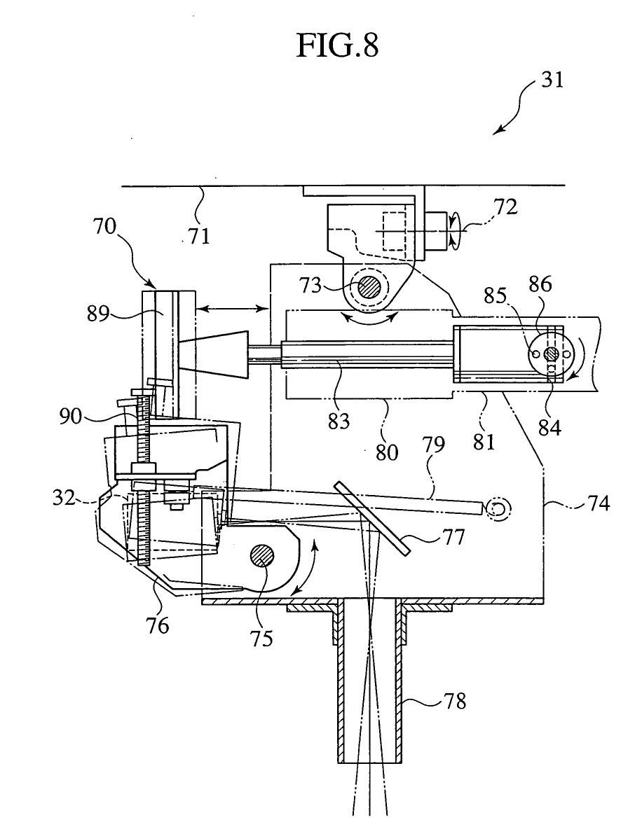

As shown in FIGS. 7 and 8, the holding device 70 includes a base frame 74 attached onto an appropriate fixed frame 71 provided in the case 10 while interposing a lateral axle 72 and a longitudinal axle 73 therebetween such that an angle of the base frame 74 is adjustable to every direction.

On the base frame 74, provided are a swinging frame 76 attached onto the base frame 74 while interposing a spindle 75 therebetween so as to be swingable in a fore-and-aft direction, a mirror 77 reflecting a laser beam generated from the semiconductor laser unit 32 positioned and fixed to the swinging frame 76, a cylindrical body 78 through which the laser beam reflected on the mirror 77 passes and is radiated, and a spring 79 energizing the swinging frame 76 to a clockwise direction in FIG. 8.

Moreover, on the base frame 74, a cylindrical support 80 having a through hole is fixed, and a hollow portion 81 is provided continuously to a right side of the support 80. An upper frame 82 is fixed to an upper right side of the hollow portion 81. Into the through hole of the support 80, a movable axle 83 capable of going forward and back along an axis thereof is inserted. A plate-shaped right end portion of the movable axle 83 is extended into the hollow portion 81, and on an upper surface in the vicinity of a tip of the movable axle 83, a long groove 84 in the fore-and-aft direction is formed. A rotary disc 86 in which pins 85 engaged with the long groove 84 are protruded downward is rotatably supported in the hollow portion 81. Onto the upper frame 82, a transmission gear mechanism 87 and a variable-speed motor 88 rotating the rotary disc 86 through the transmission gear mechanism 87 are attached. When the motor 88 rotates in one direction, such rotation of the rotary disc 86 is transmitted to the movable axle 83 through the pin 85 and the long groove 84, and the movable axle 83 goes forward and back by a predetermined stroke.

An operating plate 89 is fixed to a left end of the movable axle 83. A head portion of a range setting member 90 provided so as to be positionally adjustable in the fore-and-aft direction in order to set a swinging range of the laser beam to the swinging frame 76 abuts on the operating plate 89 by energizing force of the spring 79. When the range setting member 90 is extended toward the back to position the head portion thereon, the operating plate 89 advances or retreats the head portion of the range setting member 90 by a predetermined stroke in response to that the movable axle 83 goes forward and back by a predetermined stroke. Thus, the swinging frame 76 swings within a relatively narrow swinging range. Meanwhile, when the range setting member 90 is extended to the front to position the head portion thereon, the operating plate 89 advances or retreats the head portion of the range setting member 90 by a predetermined stroke in response to that the movable axle 83 goes forward and back by a predetermined stroke. Thus, the swinging frame 76 swings within a relatively wide swinging range.

### Third Embodiment

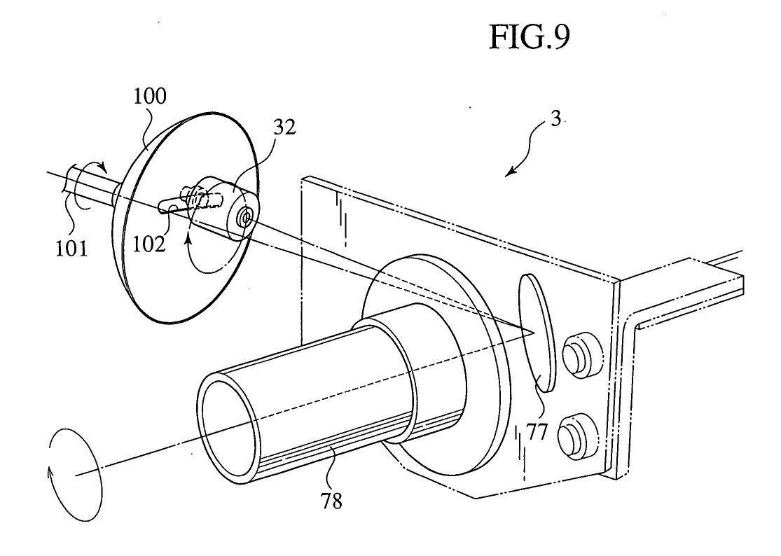

As shown in FIG. 9, a disaster-related warning apparatus 3 is substantially similar to the disaster-related warning apparatus 2 shown in FIGS. 6 to 8, and accordingly, similar portions thereof to those of the disaster-related warning apparatus 2 are shown while being added with the same reference numerals as those for use in FIGS. 6 to 8. The disaster-related warning apparatus 3 is different from the disaster-related warning apparatus 2 in that the disaster-related warning apparatus 3 rotates the laser beam while the disaster-related warning apparatus 2 swings the laser beam.

Specifically, the disaster-related warning apparatus 3 includes a rotary frame 100 of a shape formed by cutting a part of a spherical surface instead of the swinging frame 76 of the disaster-related warning apparatus 2. The rotary frame 100 rotates in one direction around a rotary axle 101 by an operation of an unillustrated variable-speed motor. Moreover, in the rotary frame 100, a long hole 102 extended along a radius direction from near the center thereof is formed, and an attachment axle portion of a semiconductor laser unit 32 is positioned and fixed to a predetermined position in this long hole 10. A curved surface of the rotary frame 100 is formed with such a curvature that a laser beam generated from the semiconductor laser unit 32 is reflected on substantially one point (near the center) of a mirror 77 no matter which position in the long hole 102 the semiconductor laser unit 32 may be positioned and fixed to.

Therefore, when the semiconductor laser unit 32 is positioned and fixed near the center of the rotary frame 100, the laser beam generated from the semiconductor laser unit 32 draws a relatively small circle. Meanwhile, when the semiconductor laser unit 32 is positioned and fixed apart from the center of the rotary frame 100, the laser beam generated from the semiconductor laser unit 32 draws a relatively large circle.

### Fourth Embodiment

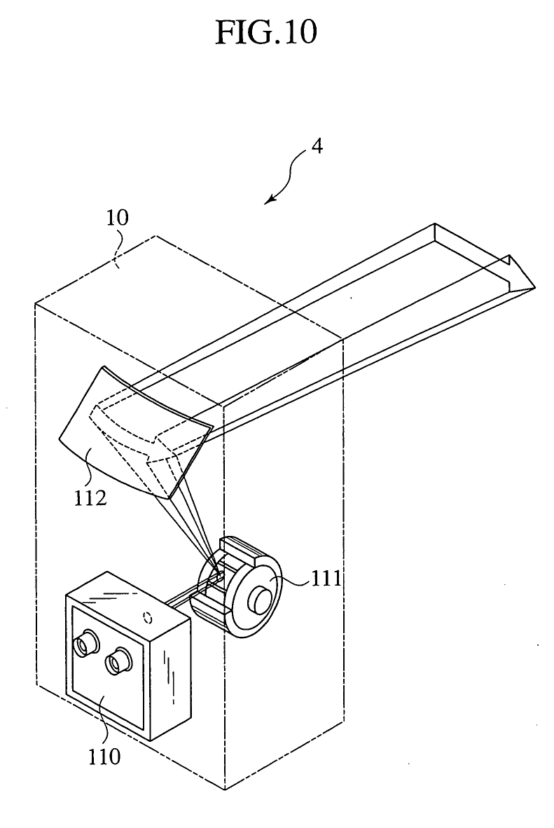

As shown in FIG. 10, a disaster-related warning apparatus 4 is one displaying an arbitrary illustration, for example, such as an arrow indicating a direction to an emergency exit on a wall surface and the like of an evacuation passage in a building by use of a laser pointer 31 (not shown). In order to realize such a display, the disaster-related warning apparatus 4 includes a laser beam swing generation device 110 attached with semiconductor laser units 32, a polygon mirror 111 rotating around an axle, and a concave mirror 112.

Although not being concretely illustrated, for example, the laser beam swing generation device 110 uses a mechanism of the swinging system of the semiconductor laser unit 32 as shown in FIGS. 7 and 8, and a mechanism of always converging the laser beam generated from the semiconductor laser unit 32 on substantially one point (near the center) of the mirror 77 as shown in FIG. 9. Thus, the laser beam swing generation device 110 is constituted such that the semiconductor laser unit 32 (not shown) swings left and right and that the generated laser beam always converges on substantially one point (near the center) of the polygon mirror 111.

The left and right swing of the laser beam by the laser beam swing generation device 110 and the up and down displacement of the laser beam by the rotating polygon mirror 111, which are described as above, are combined, thus making it possible to display, for example, an arrow as indicated by a dashed line on the concave mirror 112. Then, the concave mirror 112 performs a necessary correction of a diffusion angle for an image (arrow) incident thereonto, and displays a reflected image (arrow) with a required size on a predetermined wall surface and the like.

Moreover, as the illustration to be displayed, a simple character is also possible. Furthermore, a specific illustration is fixedly drawn in advance on the concave mirror 112, and a treatment which does not allow the laser beam to be reflected is performed for other portions than a portion where the illustration is drawn, thus making it possible to realize the display of the illustration more simply.

### Fifth Embodiment

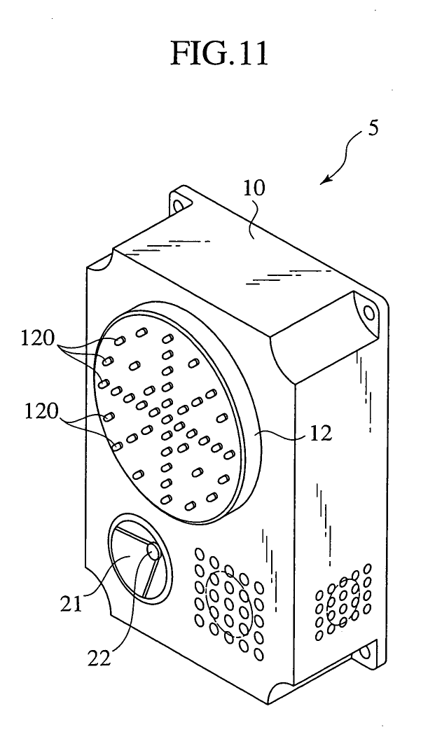

As shown in FIG. 11, a disaster-related warning apparatus 5 is one achieving a cost reduction by utilizing LEDs (light emitting diodes) 120 instead of the semiconductor laser unit 32. Specifically, in this disaster-related warning apparatus 5, the large number of highly bright LEDs 120 are arrayed in a shape of concentric circles on a circular pedestal 12 of a case 10. These LEDs 120 are driven to blink so as to be sequentially lighted from ones arrayed on an inner peripheral position to ones arrayed on an outer peripheral position. Directly, this disaster-related warning apparatus 5 is very conspicuous though cannot indicate a distant object indirectly. Accordingly, the disaster-related warning apparatus 5 is previously attached in the vicinity of a fire extinguisher or the like to be noted in case of an occurrence of a disaster, thus making it possible to know a position of the fire extinguisher easily even under such a dark environment where lighting is lost.

Note that, in one of the above-described embodiments, for the disaster sensing means 20, totally four types of sensors are used, which are the temperature sensor 21, the gas sensor 22 and the sound sensor 23 as the fire sensing means, and the vibration sensor 24 as the earthquake sensing means. However, no limitations are imposed on the above, and according to needs, it is possible to use, for example, only one to three types of sensors thereamong, and moreover, it is also possible to use an appropriate sensor other than the above.

Moreover, in the above-described embodiments, for the notification means 30, the laser pointers 31 or the LEDs 120 as the optical notification means and the audio generation device 50 as the audio notification means are used. However, no limitations are imposed on the above, and according to needs, it is possible to use, for example, only either one of the optical notification means and the audio notification means.

Furthermore, in the above-described embodiments, the unillustrated battery is provided in the case 10, and thus the disaster-related warning apparatus 1 is constituted so as to be installable by being attached onto the ceiling, the wall, the fire extinguisher or the like without any wiring. However, no limitations are imposed on the above, and according to needs, not the battery but an AC power source is utilized, thus making it also possible to constitute the disaster-related warning apparatus 1 installed, fore example, on a high ceiling to be maintenance free by eliminating a necessity of a battery exchange. Moreover, it is also possible to use the disaster-related warning apparatus 1 which includes the battery in the case 10 and the disaster-related warning apparatus 1 which does not include the battery but utilizes the AC power source in selective combination in accordance with an installation place and the like.

### INDUSTRIAL APPLICABILITY

As described above, the disaster-related warning apparatus of the present invention includes the disaster sensing means for outputting a detection signal upon sensing a predetermined type of disaster, and the notification means for instructing a person about the location of the emergency equipment or appliances prepared for the disaster optically or by the audio message, the notification means being activated in response to the detection signal of the disaster sensing means. Accordingly, the disaster-related warning apparatus automatically operates upon sensing an occurrence of the disaster, and can clearly instruct the person about the position of the emergency equipment or emergency appliances by appealing to either one or both of visual and auditory sensations thereof.

Thus, in case of the occurrence of the disaster, a clear instruction can be made to a fire operator and an evacuee about the emergency equipment or the emergency appliances, for example, such as the fire extinguisher and the emergency exit. Accordingly, expansions of physical and property damages caused by that the locations of the emergency equipment and appliances are inapparent due to a panic and a nonarounsal state of mentality can be restricted to the minimum. Hence, the disaster-related warning apparatus of the present invention is useful as a disaster-related warning apparatus.

1. A disaster-related warning apparatus housed in a case installable to either of a building and equipment, comprising:
at least one type of disaster sensing means for outputting a detection signal upon sensing a predetermined type of disaster; and
notification means for making an instruction about a location of either of emergency equipment and appliance prepared for the disaster optically or by an audio message, the notification means being activated in response to the detection signal outputted by the disaster sensing means.

2. The disaster-related warning apparatus according to claim 1, wherein the disaster sensing means includes any of a temperature sensor for sensing heat in case of fire, a gas sensor for sensing smoke in case of the fire, a sound sensor for sensing an alarm sound of an emergency bell, and a vibration sensor for sensing an earthquake.

3. The disaster-related warning apparatus according to claim 1, wherein the notification means includes either of a laser pointer and an LED, and the laser pointer is constituted such that a pointing orientation is arbitrarily adjustable and a beam is swingable within a required range while using a set pointing orientation as a reference.

4. The disaster-related warning apparatus according to claim 1, wherein the notification means includes recording means capable of recording and reproducing at least one type of audio message corresponding to the type of disaster.

5. A disaster-related warning apparatus to be used by being attached onto either of a building and equipment, comprising:
fire sensing means for outputting a detection signal upon sensing any of heat and smoke in case of fire and an alarm sound of an emergency bell;
earthquake sensing means for outputting a detection signal upon sensing an earthquake;
optical notification means capable of making an optical instruction about a location of either of emergency equipment and appliance prepared for a disaster;
fire-case audio notification means capable of issuing an audio message to instruct about the location of either of the emergency equipment and appliance prepared for the disaster as well as an audio message corresponding to an occurrence of a fire;
earthquake-case audio notification means capable of issuing the audio message to instruct about the location of either of the emergency equipment and appliance prepared for the disaster as well as an audio message corresponding to an occurrence of an earthquake; and
controlling means for selecting either one of the fire-case audio notification means and the earthquake-case notification means and activating the optical notification means and the selected one of the fire-case audio notification means and the earthquake-case notification means based on the detection signal outputted by either thereof,
wherein the controlling means activates the optical notification means and the fire-case audio notification means upon receiving the detection signal only from the fire sensing means, operates the optical notification means and the earthquake-case audio notification means upon receiving the detection signal only from the earthquake sensing means, and operates the optical notification means and the fire-case audio notification means upon receiving the detection signals from the fire sensing means and the earthquake sensing means.
